(19) United States
(12) Patent Application Publication
(10) Pub. No.: US 2025/0266528 A1
(43) Pub. Date: Aug. 21, 2025

(54) Battery Modules Comprising Immersion-Cooled Prismatic Battery Cells and Methods of Fabricating Thereof

(71) Applicant: DIMAAG-AI Inc., Fremont, CA (US)

(72) Inventors: Ian Wright, Woodside, CA (US); Brian Graf, Fremont, CA (US)

(21) Appl. No.: 19/197,036

(22) Filed: May 2, 2025

Related U.S. Application Data
(63) Continuation-in-part of application No. PCT/US2024/012274, filed on Jan. 19, 2024.
(60) Provisional application No. 63/480,710, filed on Jan. 20, 2023.

(51) Int. Cl. H01M 10/6568; H01M 10/613; H01M 10/625; H01M 10/647; H01M 50/209; H01M 50/258

(52) U.S. Cl. CPC H01M 10/6568; H01M 10/613; H01M 10/625; H01M 10/647; H01M 50/209; H01M 50/258; H01M 2220/20

(57) ABSTRACT

Described herein are battery modules comprising immersion-cooled prismatic battery cells and methods of fabricating thereof. A battery module comprises prismatic battery cells that are stacked along the primary module axis. The module also comprises top, bottom, and side covers and two end plates, collectively enclosing these battery cells. Each cover forms two fluid channels, both fluidically open to the prismatic battery cells. Furthermore, the module comprises bus bars that interconnect the cell terminals and protrude into the fluid channels formed by the top cover. One end plate comprises two fluid ports for connecting to a thermal management system. Each port is fluidically coupled to one fluid channel, formed by the top cover, and one fluid channel, formed by the bottom cover. The other end plate fluidically couples the two fluid channels, formed by the top cover, and, separately, the two fluid channels, formed by the bottom cover.

### CROSS-REFERENCE TO RELATED APPLICATIONS

This application is a continuation-in-part of PCT/US2024/012274 filed on 2024 Jan. 19, which claims the benefit under 35 U.S.C. § 119(e) of U.S. Provisional Patent Application 63/480,710, filed on 2023 Jan. 20, which is incorporated herein by reference in its entirety for all purposes.

### BACKGROUND

Electric vehicles are propelled using electric motors powered by battery packs. Each battery pack can include one or more battery modules, each comprising one or more battery cells. These cells can be connected in series and/or parallel and controlled by a battery management system. While the operating temperature of battery cells depends on various materials used to fabricate these cells (e.g., electrolyte solvents), most battery cells are designed to operate in the 0-60° C. range. It should be noted that battery cells can be very sensitive to their operating temperatures. For example, the power rating of battery cells can drop quickly with the temperature (caused by lower ionic mobility). At the same time, battery cells degrade faster and can potentially enter unsafe conditions when operated at high temperatures.

In addition to various environmental conditions that can change cells' operating temperature, battery cells can generate considerable heat while charging and discharging, especially at high rates (that can be desirable for many applications). For example, Joule heating caused by cells' internal resistance is one of the largest contributors. Other contributors include but are not limited to electrode reactions and entropic heat generation caused by the insertion and de-insertion of lithium ions in and out of the electrodes. To maintain optimum operating temperatures, the heat must be removed from the battery cells as this heat is being generated within the cells. It should be noted that other components of battery packs (e.g., bus bars that interconnect battery cells) can also cause heating and should be also cooled whenever possible.

Liquid cooling or, more generally, liquid-based thermal management of battery cells is beneficial in comparison to, e.g., air cooling because of the large heat capacities and heat transfer coefficient of many liquids in comparison to air. However, controlling the distribution of liquid within battery packs can be challenging. For example, most liquid-cooled battery packs have battery cells isolated from liquid passages thereby preventing any direct contact between the cells and thermal liquid and relying on various heat-transferring components positioned in between. Furthermore, many liquid-cooled battery packs utilize cylindrical cells (e.g., 18650 cells) because of their small factor and ease of cooling (e.g., by thermal coupling to cell bottoms). However, battery packs with cylindrical cells tend to have lower energy density because of their inherent packing density limitations. Finally, most battery cooling systems focus on cooling batteries and ignore bus bar cooling.

What is needed are new battery modules comprising immersion-cooled prismatic battery cells and methods of fabricating thereof.

### SUMMARY

Described herein are battery modules comprising immersion-cooled prismatic battery cells and methods of fabricating thereof. A battery module comprises prismatic battery cells that are stacked along the primary module axis. The module also comprises top, bottom, and side covers and two end plates, collectively enclosing these battery cells. Each cover forms two fluid channels, both fluidically open to the prismatic battery cells. Furthermore, the module comprises bus bars that interconnect the cell terminals and protrude into the fluid channels formed by the top cover. One end plate comprises two fluid ports for connecting to a thermal management system. Each port is fluidically coupled to one fluid channel, formed by the top cover, and one fluid channel, formed by the bottom cover. The other end plate fluidically couples the two fluid channels, formed by the top cover, and, separately, the two fluid channels, formed by the bottom cover.

### BRIEF DESCRIPTION OF THE DRAWINGS

FIG. 1 is a block diagram of an electric vehicle comprising a battery pack having one or more battery modules with immersion-cooled battery cells, in accordance with some examples.

FIG. 2 is a schematic illustration of a battery module comprising immersion-cooled battery cells, in accordance with some examples.

FIG. 3A is a schematic perspective view of a stack of prismatic battery cells, in accordance with some examples.

FIG. 3B is a schematic side view of the stack of prismatic battery cells in FIG. 3A, in accordance with some examples.

FIG. 3C is a schematic side view of two cells in the stack of prismatic battery cells in FIG. 3A, in accordance with some examples.

FIG. 4A is a schematic perspective view of a stack of prismatic battery cells and bus bars, in accordance with some examples.

FIGS. 4B and 4C are schematic cross-sectional side views of two types of connection between a bus bar and a cell terminal, in accordance with some examples.

FIG. 5A is a schematic perspective view of a stack of prismatic battery cells partially enclosed with top, bottom, and side covers, in accordance with some examples.

FIG. 5B is a schematic expanded view of a corner of the stack of prismatic battery cells in FIG. 5A.

FIG. 5C is a schematic front view of the stack of prismatic battery cells in FIG. 5A.

FIG. 6A is a schematic perspective view of a battery module illustrating a first cover attached to the top, bottom, and side covers, in accordance with some examples.

FIG. 6B is a schematic perspective view of the battery module in FIG. 6A, with an exploded view of the first cover.

FIGS. 7A and 7B are perspective front and back views of a first cover, in accordance with some examples.

FIGS. 7C and 7D are front and back views of the first cover in FIG. 7A.

FIG. 7E is a side view of the first cover in FIG. 7A.

FIG. 7F is a cross-sectional view of the first cover in FIG. 7A.

FIGS. 7G and 7H are front and cross-sectional views of a second-cover center portion, in accordance with some examples.

FIG. 7I is a schematic representation of thermal modeling in a battery module, in accordance with some examples.

FIG. 8A is a schematic front view of a battery pack comprising 12 interconnected battery modules, in accordance with some examples.

FIG. 8B is a schematic expanded view of an interconnecting plate used in the battery pack in FIG. 8A.

FIG. 9 is a process flowchart of a method for fabricating a battery module comprising immersion-cooled battery cells, in accordance with some examples.

FIG. 10A is a schematic perspective view of a battery pack comprising 13 interconnected battery modules, in accordance with some examples.

FIGS. 10B-10D are schematic perspective and front views of the battery pack in FIG. 10A with end covers removed to illustrate interconnecting units used for supporting the battery modules relative to each other, in accordance with some examples.

FIG. 11A is a schematic perspective view of a portion of the battery pack in FIG. 10A, illustrating an interconnecting unit attached to four battery modules, in accordance with some examples.

FIG. 11B is a schematic perspective view of the four battery modules in FIG. 11A with the interconnecting unit removed, illustrating the engagement units of the four battery modules to which the interconnecting unit is configured to attach, in accordance with some examples.

FIG. 11C is a schematic cross-sectional view of two battery modules and interconnecting unit attached to the engagement units of these battery modules, in accordance with some examples.

FIG. 11D is an expanded view of the portion of the two battery modules and interconnecting unit in FIG. 11C.

FIG. 11E is an expanded view of the two battery modules and interconnecting unit in FIG. 11D prior to inserting the protrusion of the interconnecting unit into the unit opening, in accordance with some examples.

FIGS. 11F and 11G are schematic perspective views of a circular interconnecting unit configured to interconnect four engagement units of different battery modules, in accordance with some examples.

FIGS. 11H and 11I are schematic perspective views of a three-quarter circular interconnecting unit configured to interconnect three engagement units of different battery modules, in accordance with some examples.

FIGS. 11J and 11K are schematic perspective views of a semi-circular interconnecting unit configured to interconnect two engagement units of different battery modules, in accordance with some examples.

FIGS. 11L and 11M are schematic perspective views of a quarter-circular interconnecting unit configured to connect to the engagement units of a single battery module and provide support to an end cover, in accordance with some examples.

FIGS. 12A and 12B are schematic perspective views of first and second end plates illustrating four engagement units of each end plate, in accordance with some examples.

FIG. 12C is a side view of two battery modules, illustrating the first end plates of these modules contacting each other while forming a gap between the top cover of one module and the bottom cover of the other module, in accordance with some examples.

FIGS. 13A and 13B are exploded and assembled/cross-sectional view of a first end plate, in accordance with some examples.

FIGS. 14A and 14B are exploded and assembled/cross-sectional view of a second end plate, in accordance with some examples.

### DETAILED DESCRIPTION

In the following description, numerous specific details are outlined to provide a thorough understanding of the present invention. The present invention may be practiced without some or all of these specific details. In other instances, well-known process operations have not been described in detail to avoid obscuring the present invention. While the invention will be described in conjunction with the specific examples, it will be understood that it is not intended to limit the invention to the examples.

### Introduction

As noted above, battery cells can be very sensitive to operating temperatures. At the same time, these temperatures can be influenced by the environment and by the cells' operation (e.g., self-heating). Liquid-based thermal management provides efficient ways of controlling the temperature of battery cells. However, the thermal coupling of battery cells and thermal liquids can be challenging. The immersion cooling of battery cells brings battery cells in direct contact with thermal liquids, which is beneficial for thermal transfer. The key challenges include controlling the distribution and flow of thermal liquids around battery cells and other components (e.g., bus bars).

Described herein are battery modules comprising immersion-cooled prismatic battery cells and methods of fabricating thereof. Specifically, each battery cell comes in direct contact with a thermal liquid (e.g., mineral oil such as transformer oil) at two locations on the top surfaces and two additional locations on the bottom surface. The thermal-liquid immersion cooling should be distinguished from other cooling methods where cooled elements do not come in contact with the cooling liquid (e.g., separated by other components) and/or gas-phase materials (e.g., air) are used for cooling. Immersion cooling involves the submersion of various battery module components into a thermal liquid (which may be also referred to as a dielectric liquid) to dissipate heat. The benefits of immersion cooling include but are not limited to (1) efficient heat dissipation and cooling uniformity (e.g., the liquid surrounding the submerged components absorbs heat more effectively, relative to air cooling, preventing overheating and ensuring optimal performance), (2) energy efficiency (e.g., requiring less power to flow the thermal liquid in comparison to flowing air to achieve the same level of cooling), (3) higher operating capabilities of battery module/higher heat dissipation rates (e.g., the thermal liquid coolant being a more efficient heat conductor than air), (4) silent operation (e.g., air cooling systems that involve fans and other mechanical components producing noise, immersion cooling is generally quieter), (5) space savings, (e.g., a higher hardware density and reduced need for extensive air cooling infrastructure can result in space savings). This is especially valuable in situations where physical space is limited or costly.

A battery module comprises at least a top cover and a bottom cover. Each cover is attached (e.g., glued) to the respective sides of the battery cells and forms two fluid channels, both fluidically open to the prismatic battery cells. Specifically, parts of the cells' top surfaces form one side of each top fluid channel. Similarly, parts of the cells' bottom surfaces form one side of each bottom fluid channel. It should be noted that the top and bottom are used in this description solely for differentiating purposes and not to indicate or limit the orientation of battery modules or each component. For example, depending on the orientation of battery modules, the bottom cover can be positioned above the top cover when a gravitational force is used as a reference. Furthermore, the module comprises bus bars that interconnect the cell terminals and protrude into the fluid channels formed by the top cover. As such, the thermal liquid comes in direct contact with the battery cells, bus bars, and any connections between the battery cells and bus bars (e.g., weld nuggets) thereby providing direct cooling of these components through the direct conduction between these elements and the thermal liquid. It should be noted that the thermal liquid experiences extensive convection within these channels, which further enhances the heat transfer.

Furthermore, a battery module comprises end plates such that the battery cells are stacked between the two end plates. One end plate comprises two fluid ports for connecting to a thermal management system. Each port is fluidically coupled to one fluid channel, formed by the top cover, and one fluid channel, formed by the bottom cover. The other end plate fluidically couples the two fluid channels, formed by the top cover, and, separately, the two fluid channels, formed by the bottom cover.

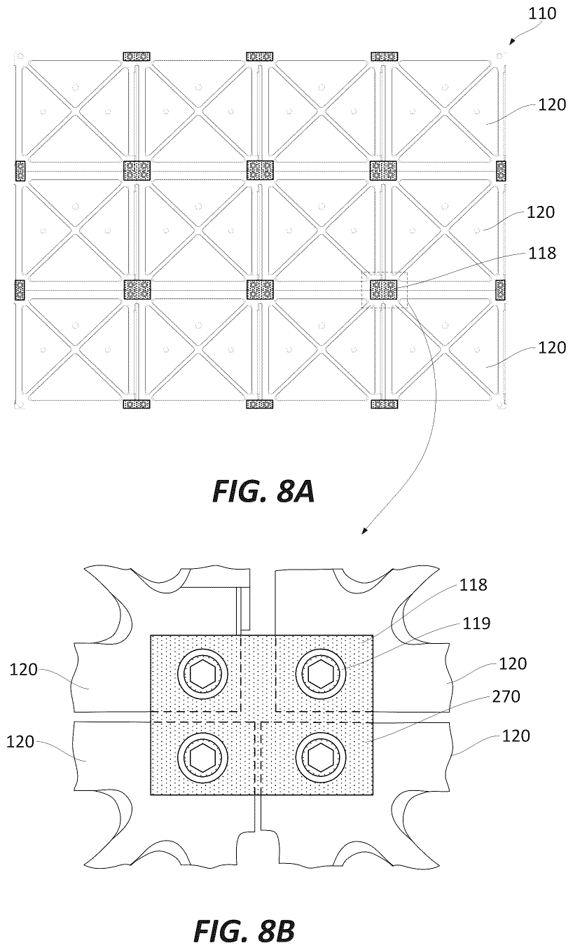

In some examples, battery cells are glued together for the structural integrity of the resulting battery module. The adhesive layers provided between the cells can also be used for the electrical isolation of battery cells and, to some extent, for the thermal isolation of the cells (both of which are safety measures). Furthermore, the direct attachment of the battery cells effectively provides some internal structural support (e.g., a module skeleton) and reduces the structural requirements from the external components, thereby reducing the weight/size of these components (and increasing the gravimetric/volumetric capacity of the module). The external support is provided by a combination of top, bottom, and side covers as well as end plates. These external components can be independently glued to the battery cells and also glued to each other. Furthermore, the end plates may have a dual-component configuration, e.g., operable as both a cover and a reinforcement element. The reinforcement element can be used for attaching the module to other components (e.g., other modules, anchor points in a battery pack, and the like), as described below with reference to FIGS. 8A-8B.

### Examples of Electric Vehicles

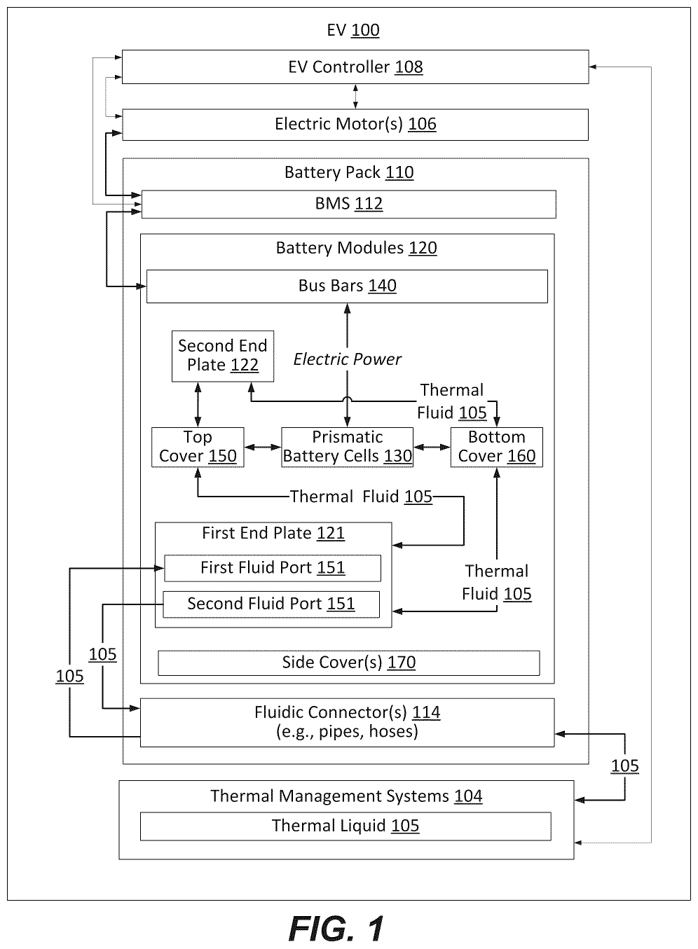

Battery modules described herein can be used in battery packs of electric vehicles. FIG. 1 is a block diagram of electric vehicle 100 comprising battery pack 110 having one or more battery modules 120 with prismatic battery cells 130, in accordance with some examples. Prismatic battery cells 130 can be also referred to as immersion-cooled battery cells or, more specifically, liquid immersion-cooled battery cells because of their direct contact with thermal liquid 105 (e.g., with at least the top surfaces 131 and the bottom surfaces 132 of the prismatic battery cells 130). Likewise, battery modules 120 may be referred to as immersion-cooled battery module or, more specifically, liquid-immersion-cooled battery module. Specifically, thermal liquid 105 is pumped between thermal management system 104 and battery modules 120. Thermal management system 104 may include pumping means (e.g., a hydraulic pump) and means for thermally conditioning thermal liquid 105 (e.g., a radiator for releasing the heat from thermal liquid 105 to the environment, a heat pump, a heater, and the like). Various fluid connectors 114 (e.g., pipes, hoses) can be used for connecting thermal management system 104 and battery modules 120. In some examples, this connection can be flexible, allowing to move battery modules 120 or, more generally, to move battery pack 110 relative to thermal management system 104. For example, battery pack 110 can move relative to thermal management system 104 to change the center of gravity of electric vehicle 100 (for stability).

Electric vehicle 100 can comprise electric motor 106 that can be electrically coupled (e.g., through an inverter and control circuitry) to battery pack 110. Electric vehicle 100 can also comprise electric vehicle controller 108, which can be coupled to various other components of electric vehicle 100. In some examples, battery pack 110 has its own controller, e.g., battery management system 112, which can be communicatively coupled to electric vehicle controller 108. In some examples, electric motor 106 is also immersion-cooled, e.g., using the same thermal management system 104 that is used for cooling the battery module 120.

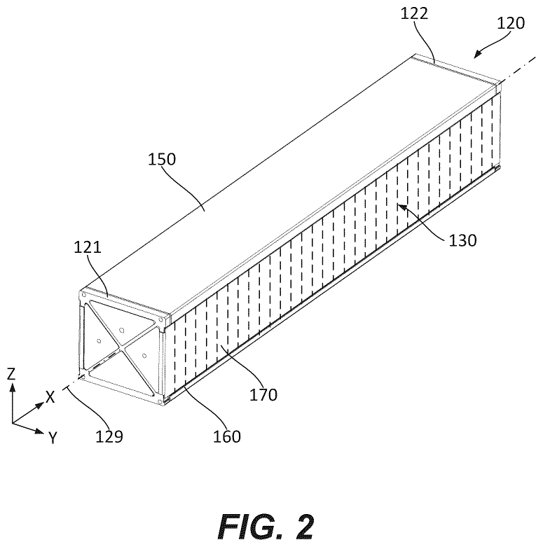

As noted above, battery module 120 comprises prismatic battery cells 130, top cover 150, bottom cover 160, side covers 170, first end plate 121, and second end plate 122, collectively enclosing these battery cells. Top cover 150 and bottom cover 160 form fluid channels to bring thermal liquid 105 in direct contact with prismatic battery cells 130. Thermal liquid 105 can be introduced to battery module 120 through first end plate 121, and first end plate 121 can distribute thermal liquid 105 among these fluid channels, formed by top cover 150 and bottom cover 160. Second end plate 122 interconnects each pair of these channels thereby providing a return path for thermal liquid 105. Additional aspects of battery module 120 will now be described with references to FIG. 2-8B.

### Examples of Battery Modules

FIG. 2 is a schematic illustration of battery module 120 comprising immersion-cooled battery cells 130, in accordance with some examples. Specifically, in the view of FIG. 2, prismatic battery cells 130 are hidden by other components such as top cover 150, bottom cover 160, side covers 170, first end plate 121, and second end plate 122. A combination of top cover 150, bottom cover 160, side covers 170, first end plate 121, and second end plate 122 enclose prismatic battery cells 130 and isolate prismatic battery cells 130 from the environment. The combination of top cover 150, bottom cover 160, first end plate 121, and second end plate 122 helps to provide immersion cooling to prismatic battery cells 130 as further described below.

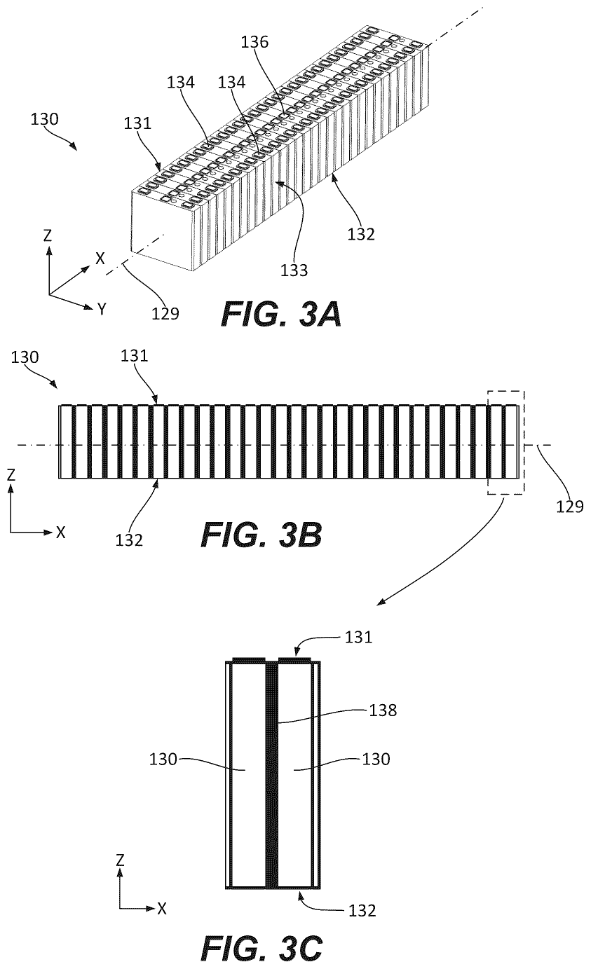

FIG. 3A is a schematic perspective view of a stack of prismatic battery cells 130, in accordance with some examples. Specifically, top cover 150, bottom cover 160, side covers 170, first end plate 121, and second end plate 122 are not shown in FIG. 3A. FIG. 3B illustrates a corresponding side view of that stack. While FIGS. 3A and 3B illustrate thirty (30) battery cells 130, one having ordinary skill in the art would understand that any number of cells can be used in one battery module 120.

Battery cells 130 used in battery module 120 are prismatic, rather than cylindrical. As noted above, prismatic battery cells 130 can be packed more compactly (with fewer spaces in between cells) within battery module 120 resulting in a higher density of battery module 120. For purposes of this description, a prismatic battery cell is defined as a cell having a shape of a rectangular prism (as opposed to a cylinder). As such, a prismatic battery cell has three distinct dimensions: (a) height, (b) width, and (c) thickness. In some examples, the height of prismatic battery cell 130 (used in battery module 120) is between 50 millimeters and 200 millimeters or, more specifically, between 75 millimeters and 125 millimeters. In the same or other examples, the width of prismatic battery cell 130 (used in battery module 120) is between 50 millimeters and 200 millimeters or, more specifically, between 75 millimeters and 125 millimeters. In some examples, the thickness of prismatic battery cell 130 (used in battery module 120) is between 5 millimeters and 50 millimeters or, more specifically, between 10 millimeters and 30 millimeters.

Prismatic battery cells 130 can be of various chemistry types, e.g., nickel-manganese-cobalt (NMC), lithium iron phosphate (LFP), and lithium titanate (LTO), at least based on the composition of positive electrodes. For example, lithium titanate (LTO) cells can support high charge-discharge rates, which may be particularly useful for industrial applications such as electric tractors, loaders, and the like.

Referring to FIGS. 3A and 3B, prismatic battery cells 130 are stacked along primary axis 129 of battery module 120. While FIG. 3A illustrates a single stack, the same battery module 120 may include multiple different stacks (e.g., positioned next to each other). Prismatic battery cells 130 comprise top surfaces 131, bottom surfaces 132 opposite to top surfaces 131, and side surfaces 133 extending between top surfaces 131 and bottom surfaces 132. For example, each top surface 131, bottom surface 132, and side surface 133 can be substantially parallel to primary axis 129. In some examples, each of prismatic battery cells 130 has a height, length, and thickness such that the thickness is less than the height and less than the length and such that the thickness is parallel to primary axis 129 of battery module 120. Prismatic battery cells 130 can be stacked along their thicknesses.

Prismatic battery cells 130 also comprise cell terminals 134 positioned on top surfaces 131. Cell terminals 134 are used to form electrical connections to prismatic battery cells 130. In some examples, cell terminals 134 are isolated from the other external components (e.g., the case, lid) of prismatic battery cells 130 such that these components are neutral. In some examples, prismatic battery cells 130 comprise pressure-release burst valves 136 configured to release gases from the interior of prismatic battery cells 130 when the pressure inside prismatic battery cells 130 exceeds a set threshold. In more specific examples, pressure-release burst valve 136 of each prismatic battery cell 130 is positioned between cell terminals 134 of that cell.

Referring to FIG. 3C, in some examples, two adjacent prismatic battery cells 130 are mechanically interconnected by adhesive layer 138 extending between prismatic battery cells 130 in each adjacent pair. Some examples of adhesive layer 138 include but are not limited to epoxy and polyurethane. The thickness of adhesive layer 138 can be used to accommodate variations in the cell thicknesses. For example, a pair of thin cells may have a thicker adhesive layer, while a pair of thick cells may have a thinner adhesive layer, such that the combined thickness is the same regardless of the cell thicknesses. Furthermore, flexible adhesives can be used to accommodate cell swelling (if any) during the operation of battery module 120. In some examples, adhesive layers 138 also provide electrical insulations between adjacent cells (e.g., even though the sides of battery cells 130 can be substantially neutral).

Adhesive layers 138 provide attachment/bonding between prismatic battery cells 130 in the set adding to the overall structural integrity of battery module 120. In other words, a combination of prismatic battery cells 130 and adhesive layers 138 is operable as an internal structural element (which can be referred to as a “skeleton”) of battery module 120. Other components of battery module 120, e.g., top cover 150, bottom cover 160, and side covers 170 are operable as an internal structural element (“exoskeleton”). Furthermore, adhesive layers 138 provide electrical isolation and, in some examples, thermal isolation of adjacent prismatic battery cells 130. While the cases of prismatic battery cells 130 can be neutral, the electrical isolation can help to improve the overall module safety (e.g., when internal shorts develop in one or more prismatic battery cells 130).

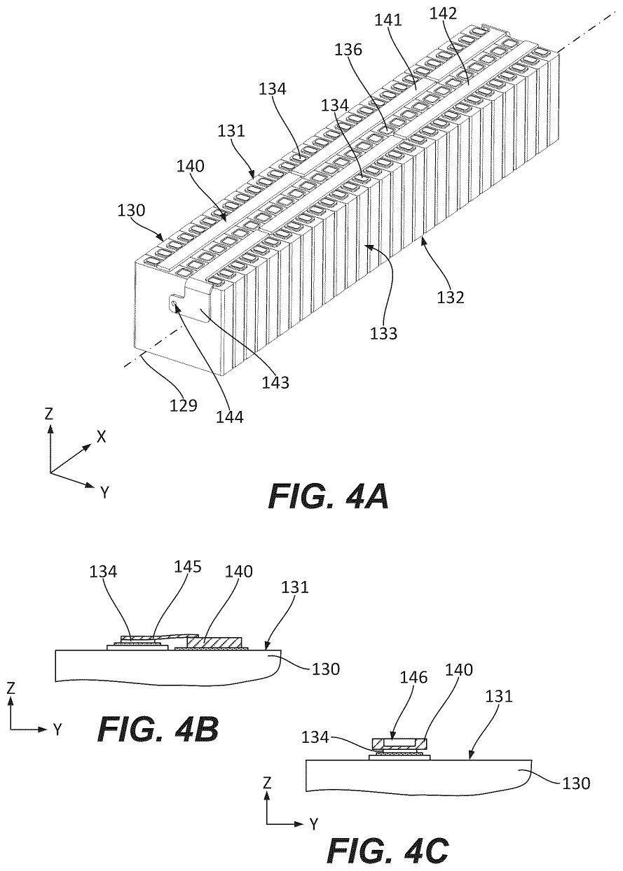

Referring to FIG. 4A, battery module 120 comprises bus bars 140 interconnecting cell terminals 134. Bus bars 140 can be made from copper, aluminum, nickel, and other suitable conductive materials. While FIG. 4A illustrates one example of cell connections (i.e., 6p-5s connection scheme, in which each 6 prismatic battery cells 130 have parallel connections forming a set, and 5 such sets are interconnected in series), other examples are also within the scope. The connection scheme depends on the required voltage output of battery module 120 and other like factors.

FIGS. 4B and 4C are schematic cross-sectional side views of two types of connection between bus bar 140 and cell terminal 134, in accordance with some examples. In FIG. 4B, the main portion of bus bar 140 is offset (along the Y-axis) relative to cell terminal 134 such that this main portion of bus bar 140 and cell terminal 134 are positioned next to each other. Bus bar 140 may comprise connecting link 145 for each cell terminal 134, extending from the main portion of bus bar 140. In some examples, this connecting link 145 is operable as a fusible link. The thickness or, more specifically, the cross-sectional area of connecting link 145 can be less than that of the main portion of bus bar 140 since, in some examples, connecting link 145 needs to support lower current ratings than the main portion of bus bar 140 (e.g., with parallel cell connections). In some examples, the thickness of connecting link 145 is selected to enable the welding of connecting link 145 to cell terminal 134. Connecting link 145 can be welded to or can be monolithic with the main portion of bus bar 140.

Referring to FIG. 4C, in some examples, bus bar 140 is positioned on the top of cell terminal 134. In this example, bus bar 140 can have bus bar opening 146 (e.g., a through opening or a blunt opening shown in FIG. 4C) that enables the welding of bus bar 140 to cell terminal 134. For example, the blunt opening may be used to form a portion of bus bar 140 that has a reduced thickness suitable for welding this portion to cell terminal 134. The rest of bus bar 140 can have a thickness suitable for current carrying. When a through opening is used, the welding can be performed around the circumference of this opening.

In some examples, bus bars 140 comprise a plurality of disjoined components, forming first bus-bar row 141 and second bus-bar row 142. In more specific examples, bus bars 140 in first bus-bar row 141 are connected to cell terminals 134 having one polarity (e.g., positive cell terminals), while bus bars 140 in second bus-bar row 142 are connected to cell terminals 134 having the other polarity (e.g., negative cell terminals). Since cell terminals 134 are positioned on top surfaces 131 (in the example shown in FIG. 4A), bus bars 140 are also positioned next to top surfaces 131. Furthermore, the interconnecting parts of first bus-bar row 141 and second bus-bar row 142 extend parallel to primary axis 129 of battery module 120.

FIG. 4A illustrates each first bus-bar row 141 and second bus-bar row 142 is formed by three separate bus-bar components. One of these bus-bar components comprises contact plate 143 to form an external electrical connection to these components. Contact plate 143 protrudes away from the interconnecting parts in a direction substantially perpendicular to primary axis 129. FIG. 4A illustrates an example where contact plates 143 are positioned on opposite sides of the stack formed by prismatic battery cells 130. However, an example where contact plates 143 are positioned on the same side of the stack is also within the scope. In some examples, contact plates 143 comprises opening 144 for protruding an electrical connector that forms the electrical connection.

It should be noted that during the operation of battery module 120, bus bars 140 are immersion-cooled as further described below. As such, the cross-section of bus bars 140 can be reduced in comparison to bus bars that are not cooled thereby allowing some resistive heating within bus bars 140. For example, the temperature coefficient of copper is about 0.00404 C⁻¹. Therefore, increasing the temperature of copper bus bars by 50° C. will cause the resistivity to increase by about 20%. Without the temperature control of bus bars 140, the dimensions of bus bars 140 need to accommodate the highest operating temperature. It should be noted that the heating of bus bars 140 can be caused by receiving the heat from battery cells 130 and also from the internal resistive heating. However, increasing the size of bus bars 140 (to accommodate for higher operating temperatures) is highly undesirable since this increases the weight and size of bus bars 140 (and as a result of battery module 120). Furthermore, bus bars 140 can be used (in addition to thermal liquid 105) for transferring the heat between battery cells 130.

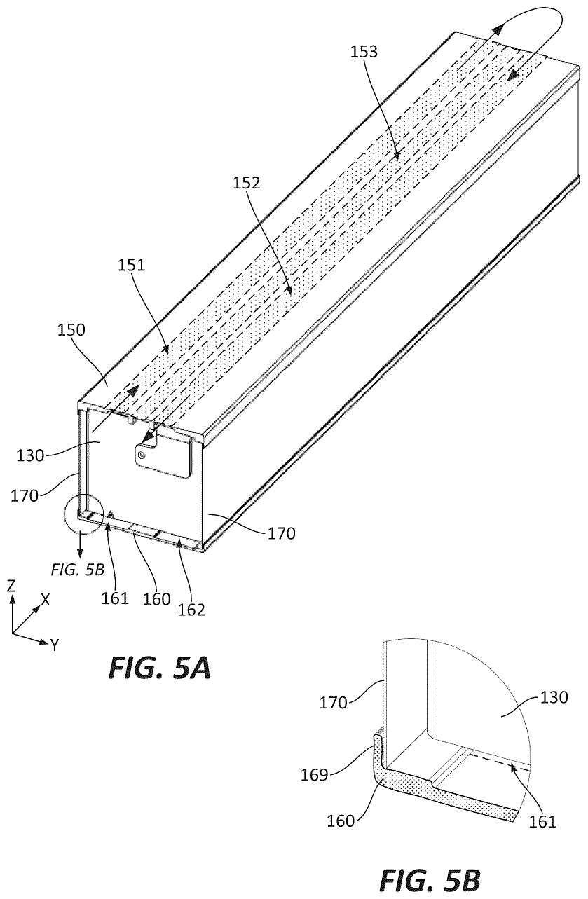

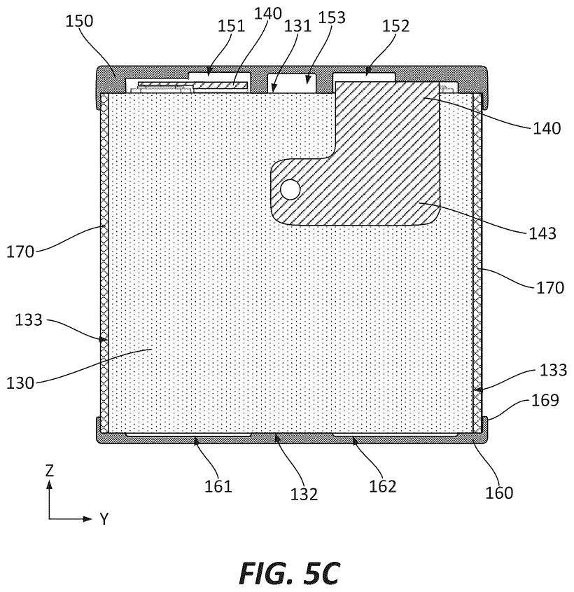

Referring to FIGS. 5A-5C, battery module 120 comprises top cover 150 and bottom cover 160. In some examples, battery module 120 also comprises side covers 170, which can be optional. Top cover 150 and bottom cover 160 can be formed from various suitable insulating materials, such as plastic.

As shown in FIG. 5C, top cover 150 is attached to prismatic battery cells 130, facing top surfaces 131. For example, top cover 150 can be glued directly to top surfaces 131 of prismatic battery cells 130. For example, epoxy, polyurethane, and other types of adhesives can be used for these purposes.

When side covers 170 are present, top cover 150 may overlap and be glued (e.g., epoxy, polyurethane) to side covers 170, e.g., as shown in FIG. 5C. In some examples, top cover 150 can be glued to both top surfaces 131 and side surfaces 133 of prismatic battery cells 130. For example, top cover 150 can extend side lips that overlap with side surfaces 133 and can be glued to side surfaces 133. Top cover 150 also forms first top fluid channel 151 and second top fluid channel 152, each fluidically open to prismatic battery cells 130. Specifically, each first top fluid channel 151 and second top fluid channel 152 are enclosed. In some examples, each first top fluid channel 151 and second top fluid channel 152 has a rectangular cross-sectional profile such that three sides are formed by top cover 150 while the remaining fourth side is formed by top surfaces 131 of prismatic battery cells 130.

In a similar manner, bottom cover 160 is attached to prismatic battery cells 130, facing bottom surfaces 132, and forms first bottom fluid channel 161 and second bottom fluid channel 162, each fluidically open to prismatic battery cells 130. For example, bottom cover 160 can be glued directly to bottom surfaces 132 of prismatic battery cells 130. When side covers 170 are present, bottom cover 160 may overlap and may be glued to side covers 170, e.g., as shown in FIG. 5C.

Overall, each prismatic battery cell 130 is immersed/comes in contact with the thermal liquid provided in all four fluid channels, i.e., first top fluid channel 151, second top fluid channel 152, first bottom fluid channel 161, and second bottom fluid channel 162. Each prismatic battery cell 130 is cooled or, more generally, thermally managed from top surface 131 and bottom surface 132 thereby ensuring more a uniform temperature profile within prismatic battery cell 130 (e.g., in comparison to one-sided cooling of battery cells). Furthermore, first top fluid channel 151 and second top fluid channel 152 are also used for cooling bus bars 140. For example, first bus-bar row 141 protrudes into first top fluid channel 151 while second bus-bar row 142 protrudes into second top fluid channel 152.

In general, the width of these fluid channels is determined by the width of battery cells 130. The fluid channels can be as wide as possible considering that top cover 150 and bottom cover 160 need to be supported relative to battery cells 130 (e.g., at least around edges) and also considering that both top channels need to be separated from each other (and only fluidically interconnected by second end plate 122). Otherwise, the width of these fluid channels can be maximized to provide maximum contact and heat transfer with battery cells 130. In other words, the fluid channels are designed to expose as much of top surfaces 131 and bottom surfaces 132 of battery cells 130 as possible. On other hands, the height of these fluid channels can be minimal to reduce the thickness of top cover 150 and bottom cover 160 and the total height of battery module 120.

Referring to FIG. 5C, in some examples, top cover 150 forms gas-venting channel 153 fluidically open to pressure-release burst valves 136. In case one or more prismatic battery cells 130 experience internal over-pressurization, the corresponding pressure-release burst valves 136 open and release internal gases (and possibly other matter) from these cells into gas-venting channel 153 thereby allowing to depressurize the cells. In some examples, gas-venting channel 153 is fluidically isolated from other components, e.g., bus bars 140, thereby preventing further propagation of unsafe conditions and even potentially continuing the operation of battery module 120. In some examples, one or both of first end plate 121 and second end plate 122 comprises burst valves to vent gases from battery module 120 (e.g., when the pressure inside gas-venting channel 153 exceeds a set threshold).

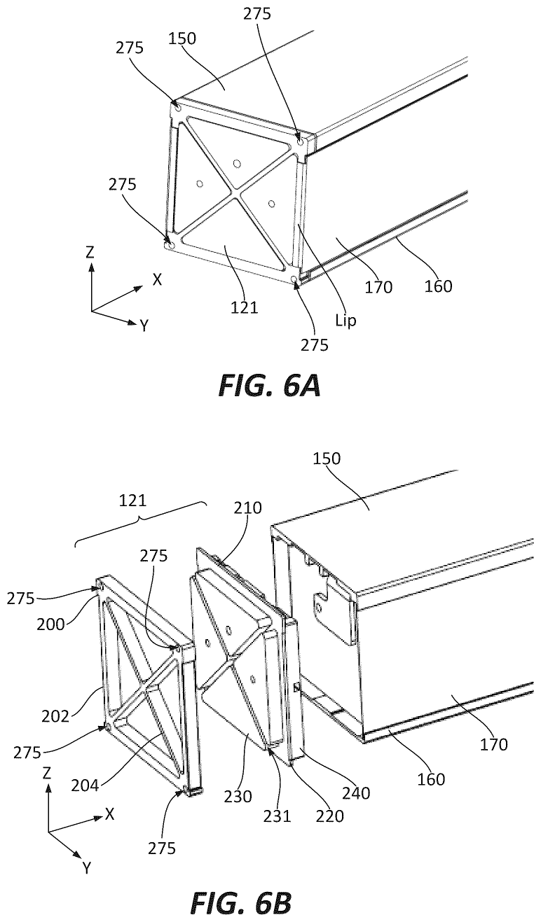

In some examples, battery module 120 further comprises side covers 170, facing side surfaces 133 of prismatic battery cells 130. Each side cover 170 is attached to top cover 150 and to bottom cover 160. For example, FIG. 5B illustrates bottom cover 160 comprising side lips 169 that overlaps with and glued to side covers 170. Top cover 150 can have a similar lip that overlaps with side covers 170. In some examples, side covers 170 are also attached to first end plate 121 and second end plate 122. For example, side covers 170 comprises first lip 171 and second lip 172 extending perpendicular to primary axis 129. For example, FIG. 6A illustrates first lip 171. First lip 171 overlaps with and is attached to first end plate 121 such that a portion of first end plate 121 extends between first lip 171 and prismatic battery cells 130. Similarly, second lip 172 overlaps with and is attached to second end plate 122 such that a portion of second end plate 122 extends between second lip 172 and prismatic battery cells 130.

Side covers 170 can be formed from aluminum and are used to provide the structural integrity to battery module 120. In some examples, a side of side covers 170 facing prismatic battery cells 130 is made from an electrically insulating material such as rubber or polymer (e.g., sprayed on battery cells 130 and/or side covers 170) to insulate the metal base of side covers 170 from prismatic battery cells 130. Even though the cases of prismatic battery cells 130 can be neutral, the electrical isolation can help to improve the overall module safety. In some examples, side covers 170 are formed from an insulating material (e.g., carbon fiber, glass fiber). Side covers 170 also provide structural support within battery module 120.

Referring to FIGS. 6A and 6B, battery module 120 comprises first end plate 121, which is attached (e.g., glued or, more specifically, sealed to) to both top cover 150 and bottom cover 160. When side covers 170 are present, first end plate 121 is also attached (e.g., glued) to side covers 170. Second end plate 122 is attached to both top cover 150 and bottom cover 160 and fluidically interconnecting first top fluid channel 151 and first bottom fluid channel 161 and, separately, fluidically interconnecting second top fluid channel 152 and second bottom fluid channel 162.

Referring to FIGS. 6A and 6B, in some examples, first end plate 121 comprises first fluid port 251 and second fluid port 252, used for fluidic connection of battery module 120 to other components of electric vehicle 100, e.g., thermal management system 104. Specifically, first fluid port 251 and second fluid port 252 allow for thermal liquid 105 to flow into and out of battery module 120 and can be referred to as inlet and outlet ports. First end plate 121 also help to fluidically couple these ports to other fluid channels within battery module 120 thereby controlling the distribution of thermal liquid 105 within battery module 120. Specifically, first fluid port 251 is fluidically coupled to both first top fluid channel 151 and first bottom fluid channel 161. Separately, second fluid port 252 is fluidically coupled to both second top fluid channel 152 and second bottom fluid channel 162. It should be noted that a combination of first fluid port 251, first top fluid channel 151, and first bottom fluid channel 161 are fluidically isolated from second fluid port 252, second top fluid channel 152, and second bottom fluid channel 162 at first end plate 121. However, first top fluid channel 151 and second top fluid channel 152 and, separately, second top fluid channel 152 and second bottom fluid channel 162 are fluidically interconnected by second end plate 122 as further described below. As such, a combination of first end plate 121 and second end plate 122 provides both distribution and looping of thermal liquid 105 within battery module 120. In this example, both first fluid port 251 and second fluid port 252 are positioned on the same side of battery module 120, i.e., first end plate 121, which helps with routing fluid connectors 114 (e.g., pipes, hoses) to the same side of battery module 120. However, examples, where first fluid port 251 and second fluid port 252 are different sides of battery module 120, are also within the scope.

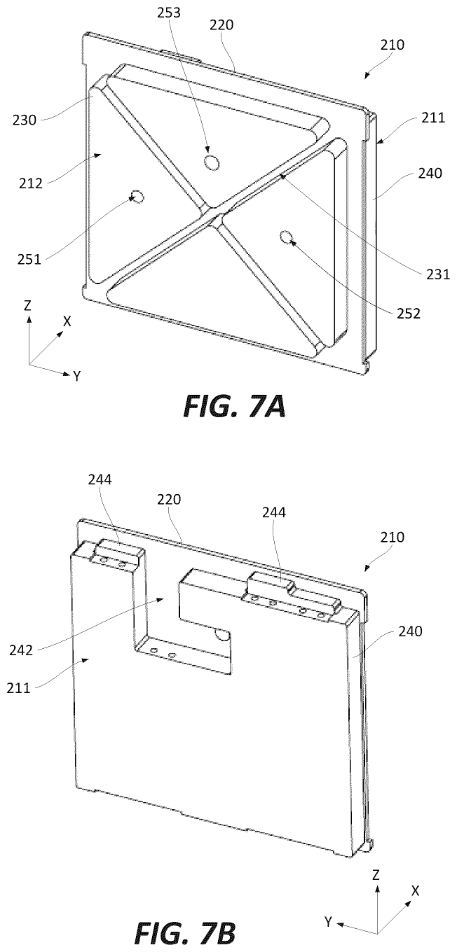

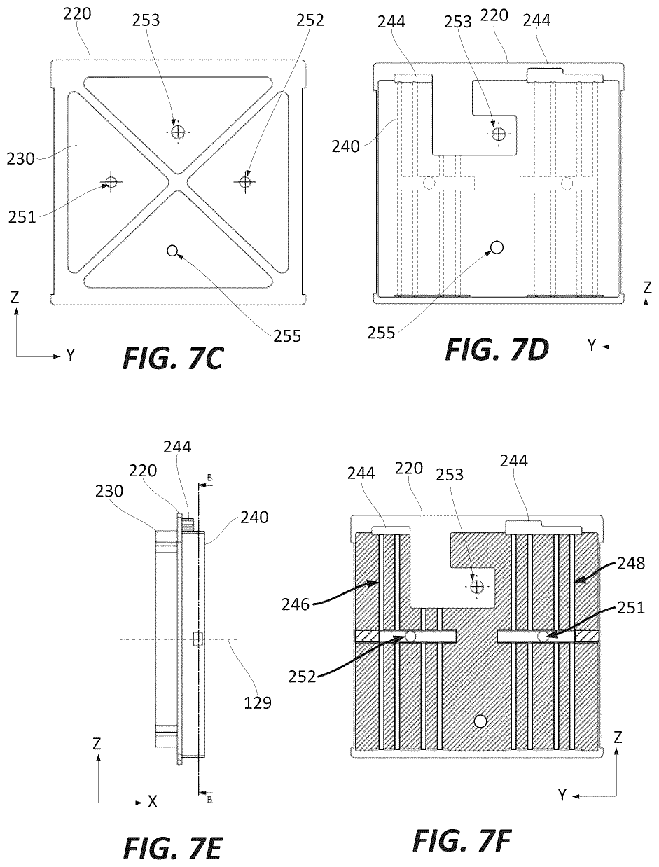

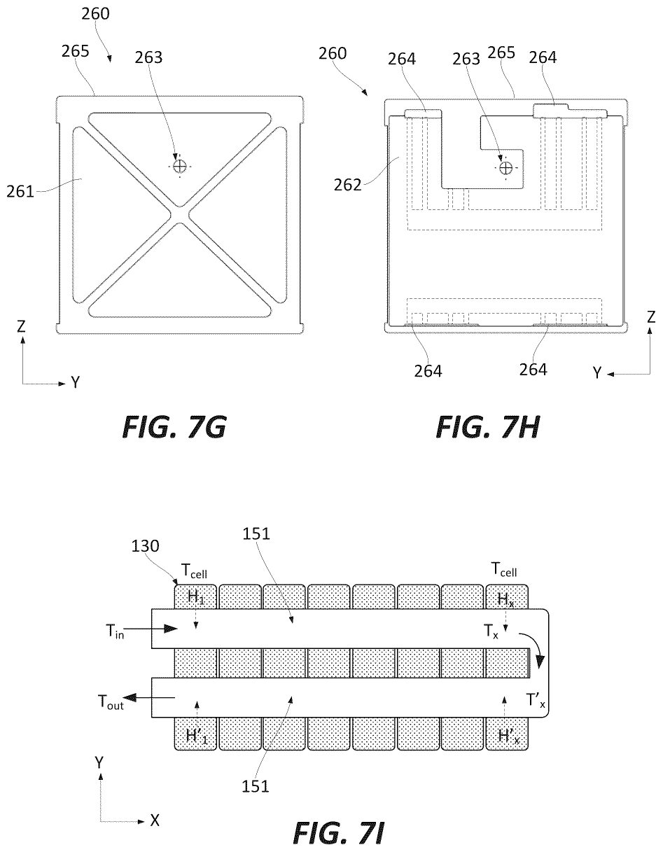

Referring to FIGS. 7A and 7C, In some examples, first end plate 121 comprises first contact opening 253 overlapping with first contact plate 143. First contact opening 253 can be used to form an electrical connection to first contact plate 143, e.g., by protruding a conductive terminal (not shown). It should be noted that this protruding terminal is sealed against first end plate 121 since first contact plate 143 is positioned on the thermal liquid side and this seal prevents the thermal liquid from leaking outside of battery module 120.

In some examples, first end plate 121 comprises signal-trace opening 255, which can be used to protrude various wires/voltage leads through first end plate 121. These wires/voltage leads can also be sealed against first end plate 121 to prevent the thermal liquid from leaking outside of battery module 120.

Referring to FIGS. 6A and 6B, in some examples, first end plate 121 comprises first reinforcement element 200 and first cover 210 formed from different materials. For example, first reinforcement element 200 can be formed from metal, such as aluminum, steel, and the like. First cover 210 can be formed from plastic. The material of first cover 210 can be selected such that first cover 210 provides electric isolation of battery cells 130 from the environment and other conductive components. Furthermore, the material of first cover 210 can simplify the fabrication of first cover 210 such as forming various internal channels for the distribution of thermal liquid 105. At the same time, first reinforcement element 200 provides structural support to first cover 210 and enables battery module 120 to connect to other battery modules as further described below. First cover 210 is inserted into the cavity formed by top cover 150, bottom cover 160, and side covers 170 and is sealed against each of these components. Furthermore, first reinforcement element 200 can be glued or otherwise attached to one or more (e.g., all) of top cover 150, bottom cover 160, and side covers 170. In some examples, side covers 170 bend around the edge of first reinforcement element 200 forming a lip, e.g., as shown in FIG. 6A. In the same or other examples, first cover 210 is at least partially positioned between first reinforcement element 200 and prismatic battery cells 130.

Referring to FIG. 6B, in some examples, first cover 210 comprises first-cover center portion 220 and first-cover outer protrusion 230, monolithic with and extending from first-cover center portion 220 away from prismatic battery cells 130. First-cover outer protrusion 230 comprises multiple pieces separated by first-cover channels 231, extending through first-cover outer protrusion 230 to first-cover center portion 220. First reinforcement element 200 comprises first reinforcement frame 202 and first reinforcement cross-member 204 such that first reinforcement frame 202 surrounds first-cover outer protrusion 230 while first reinforcement cross-member 204 protrudes into first-cover channels 231. This overlap (and the increased contact area) between first reinforcement element 200 and first cover 210, provide greater support to first cover 210 by first reinforcement element 200.

Referring to FIG. 6B, in some examples, first cover 210 further comprises first-cover inner protrusion 240, monolithic with and extending from first-cover center portion 220 toward prismatic battery cells 130. First-cover inner protrusion 240 extends into an opening formed by top cover 150 and bottom cover 160 and is attached to each of top cover 150 and bottom cover 160.

Referring to FIG. 7B, in some examples, first-cover inner protrusion 240 comprises cutout 242 such that a portion of first bus-bar row 141 extends into cutout 242.

Referring to FIGS. 7B, 7D, and 7E, in some examples, first-cover inner protrusion 240 comprises sealing extensions 244 protruding into and sealing first top fluid channel 151, second top fluid channel 152, first bottom fluid channel 161, and second bottom fluid channel 162.

Referring to FIG. 7F, in some examples, first-cover inner protrusion 240 comprises first set of internal fluid channels 246 fluidically coupling first fluid port 251 with both first top fluid channel 151 and first bottom fluid channel 161. First-cover inner protrusion 240 comprises second set of internal fluid channels 248 fluidically coupling second fluid port 252 with both second top fluid channel 152 and second bottom fluid channel 162.

First end plate 121 and second end plate 122 may have many similar features. For example, reinforcement elements of first end plate 121 and second end plate 122 may be substantially similar or even the same (and interchangeable). On other hand, first cover 210 and second cover 260 can have different designs. For example, first cover 210 comprises fluid port 251 and second fluid port 252 (operable as an inlet and outlet and described above), while second cover 260 may not have any such ports, e.g., as schematically shown in FIGS. 7G and 7H. It should be noted that positioning both inlet and outlet on the same side of battery module 120 is used to achieve uniform heat transfer from different battery cells as will now be described with reference to battery module cooling and FIG. 7I in the context of first top fluid channel 151 and second top fluid channel 152. One having ordinary skill in the art would understand that the same approach applies to battery module heating as well as first bottom fluid channel 161 and second bottom fluid channel 162.

Referring to FIG. 7I, as the thermal liquid having an inlet temperature (Tᵢₙ) enters battery module 120, the thermal liquid receives the heat (H₁) and increases the fluid temperature as the fluid continues to flow through the module. For example, upon reaching the last cell in this series, the fluid temperature (Tₓ) will be higher that the inlet temperature (Tₓ>Tᵢₙ). Assuming that all battery cells have the same temperature (T_{cell}), the first cell that comes in contact with the immediately incoming (colder) fluid will lose more heat than any subsequent cell in this series since the heat transfer is proportional to the temperature gradient between the cell and the fluid. For example, the heat transfer from the last cell in this series (Hₓ∝T_{cell}−Tₓ) will be smaller than the heat transfer from the first cell in this series (H₁∝T_{cell}−Tᵢₙ) due to the thermal liquid heating and the thermal gradient reduction (Tᵢₙ<Tₓ→H₁>Hₓ). If the thermal liquid is not looped and allowed to exit on the other side of the battery module, then the first cell will be cooled more than the last cell. However, when the thermal liquid is looped and has both first top fluid channel 151 and second top fluid channel 152 (both providing fluidic contact to each cell), there is additional heat transfer occurs from each cell. Specifically, the heat transfer provided by first top fluid channel 151 is described above resulting in the first cell will be cooled more than the last cell. However, as the thermal liquid is directed from first top fluid channel 151 to second top fluid channel 152, the order of the cell experiencing the flow is flipped while the thermal liquid continues to heat. The last cell sees this return flow first and experiences additional heat transfer (H′ₓ∝T_{cell}−T′ₓ). The first cell sees this return flow last and also experiences additional heat transfer (H′₁∝T_{cell}−Tₒᵤₜ). Since the thermal liquid continues to heat (Tₒᵤₜ>T′ₓ), the last cell is now cooled more (H′ₓ>H′₁). Combining the two heat transfers (provided by first top fluid channel 151 to second top fluid channel 152), the total heat transfer is more balanced (Hₓ+H′ₓ\tilde{ }H₁+H′₁) than the heat transfer provided by each of the channels individually.

Returning to FIGS. 7G and 7H, second cover 260 comprises second contact opening 263, which is used for connecting to one of bus bars 140. In other words, one connection to bus bars 140 is formed through first contact opening 253 in first cover 210, while the other connection to bus bars 140 is formed through second contact opening 263 in second cover 260. Having such connections on the opposite sides of battery module 120 allows forming various connections among modules. Alternatively, both contact openings are positioned on the same cover (e.g., the cover that also includes fluid ports or the cover that does not include any fluid ports).

Similar to first cover 210, second cover 260 comprises second-cover center portion 265 as well as second-cover outer protrusion 261 and second-cover inner protrusion 262, extending in opposite sides from second-cover center portion 265. Second-cover inner protrusion 262 faces battery cells 130 and extends into the cavity formed by top cover 150, bottom cover 160, and side covers 170. In some examples, second-cover inner protrusion 262 is glued to each of top cover 150, bottom cover 160, and side covers 170. Furthermore, in some examples, second-cover inner protrusion 262 comprises additional sealing extensions 264 protruding into and sealing first top fluid channel 151, second top fluid channel 152, first bottom fluid channel 161, and second bottom fluid channel 162. Finally, second-cover inner protrusion 262 comprises inner channels that fluidically couple first top fluid channel 151 and second top fluid channel 152 and, separately, fluidically couple first bottom fluid channel 161 and second bottom fluid channel 162, e.g., as schematically shown in FIG. 7H.

Referring to FIGS. 6A and 6B, in some examples, first reinforcement frame 202 comprises four openings 275, each positioned in a different corner of first reinforcement frame 202. Openings 275 can be used for connecting battery module 120 to other modules as will now be described with reference to FIGS. 8A and 8B. Specifically, FIG. 8A illustrates twelve battery modules 120 arranged into a battery pack 110 and interconnected using interconnecting units 118. FIG. 8B is an expanded view of an interconnecting unit 118 interconnecting four battery modules 120. Specifically, the interconnecting unit 118 is bolted to each of the four battery modules 120 using a fastener 119. A portion of a battery module 120 connected to an interconnecting unit 118 may be referred to as an engagement unit (further described below).

### Examples of Methods of Fabricating Battery Modules

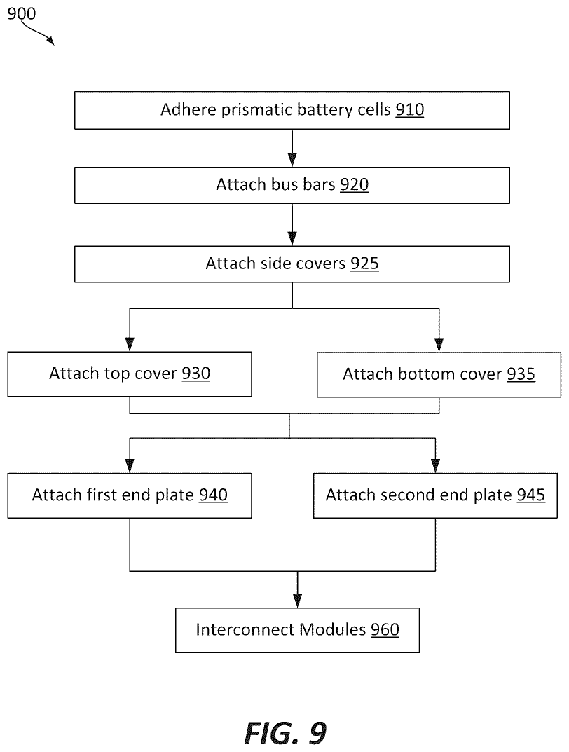

FIG. 9 is a process flowchart corresponding to method 900 of fabricating battery module 120, in accordance with some examples. Method 900 may commence with (block 910) adhering prismatic battery cells 130 stacked along primary axis 129 of battery module 120 and comprising top surfaces 131, bottom surfaces 132 opposite to top surfaces 131, side surfaces 133 extending between top surfaces 131 and bottom surfaces 132, and cell terminals 134 positioned on top surfaces 131.

Method 900 may proceed with (block 920) attaching bus bars 140 to cell terminals 134. Bus bars 140 form first bus-bar row 141 and second bus-bar row 142 and interconnecting cell terminals 134. In some examples, method 900 comprises (block 925) attaching side covers 170.

Method 900 may proceed with (block 930) attaching top cover 150 to prismatic battery cells 130 and (block 935) attaching bottom cover 160. Specifically, after these attaching operations, top cover 150 faces top surfaces 131 and forms first top fluid channel 151 and second top fluid channel 152, each fluidically open to prismatic battery cells 130. Similarly, bottom cover 160 faces bottom surfaces 132 and forms first bottom fluid channel 161 and second bottom fluid channel 162, each fluidically open to prismatic battery cells 130.

Method 900 may proceed with (block 940) attaching first end plate 121 and (block 945) attaching second end plate 122. Specifically, first end plate 121 is attached to both top cover 150 and bottom cover 160 and comprises first fluid port 251 and second fluid port 252. As described above, first fluid port 251 is fluidically coupled to both first top fluid channel 151 and first bottom fluid channel 161. Second fluid port 252 is fluidically coupled to both second top fluid channel 152 and second bottom fluid channel 162. Second end plate 122 fluidically interconnects first top fluid channel 151 and first bottom fluid channel 161 and, separately, fluidically interconnects second top fluid channel 152 and second bottom fluid channel 162.

In some examples, method 900 proceed with (block 960) interconnecting battery modules 120, e.g., using interconnecting units 118 and fasteners 119 as shown in FIGS. 8A-8B and further described below. For example, battery modules 120 may be stacked together such that their engagement units 270 (positioned at the corners of each battery module 120) contact each other. The engagement units 270 that contact each other may be referred to as an engagement unit set 279. There could be two, three, or four engagement units 270 in each engagement unit set 279. An interconnecting unit 118 may be positioned over each engagement unit set 279 such that the engagement units 270 in this engagement unit set 279 are compressed against each other. Various features of the engagement units 270 and interconnecting units 118 that enable this compression are described below. Fasteners 119 may protrude through the engagement units 270 and bolted to the corresponding engagement units 270.

### Examples of Interconnecting Battery Modules

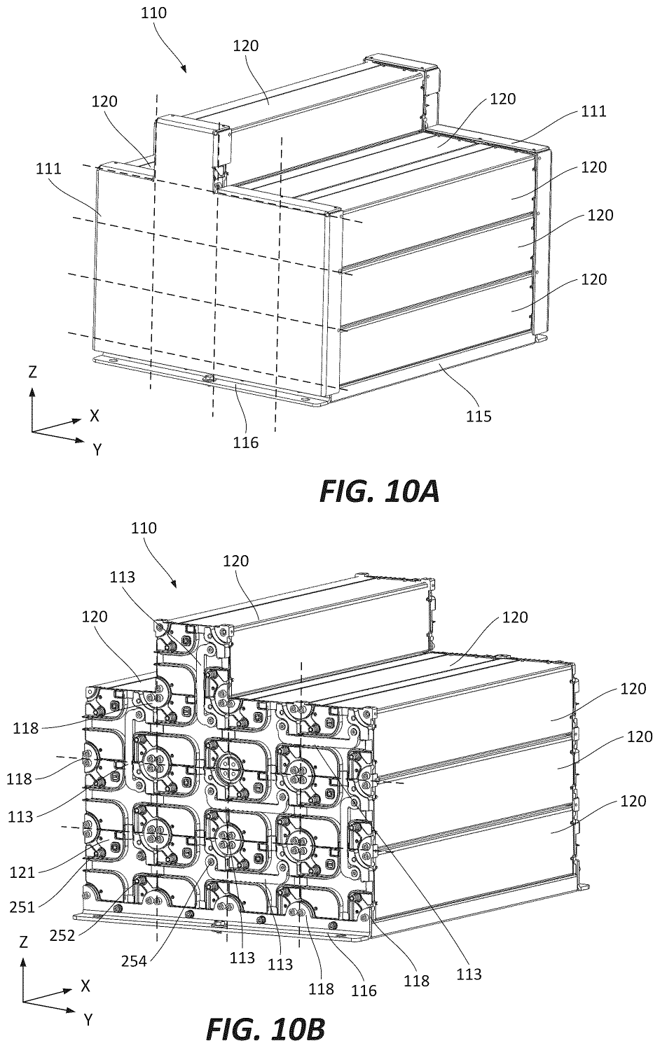

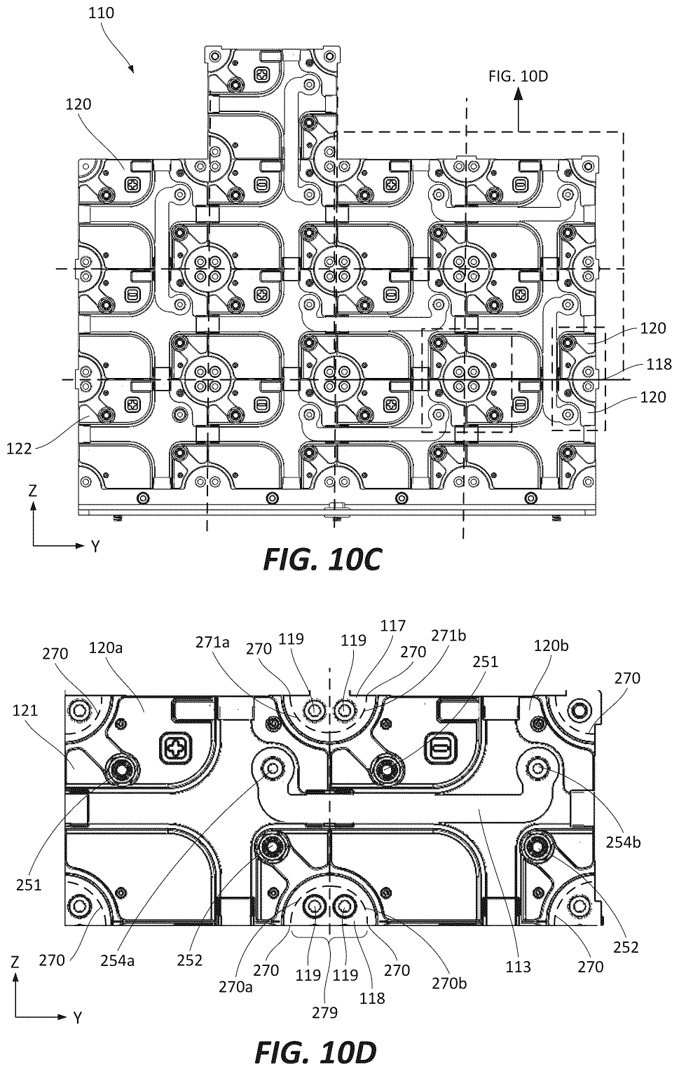

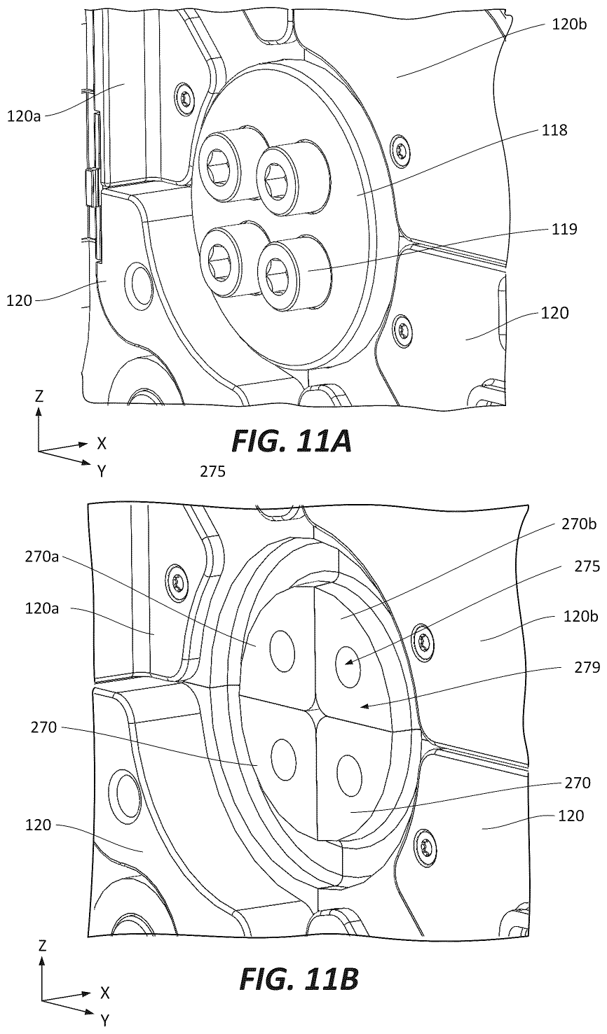

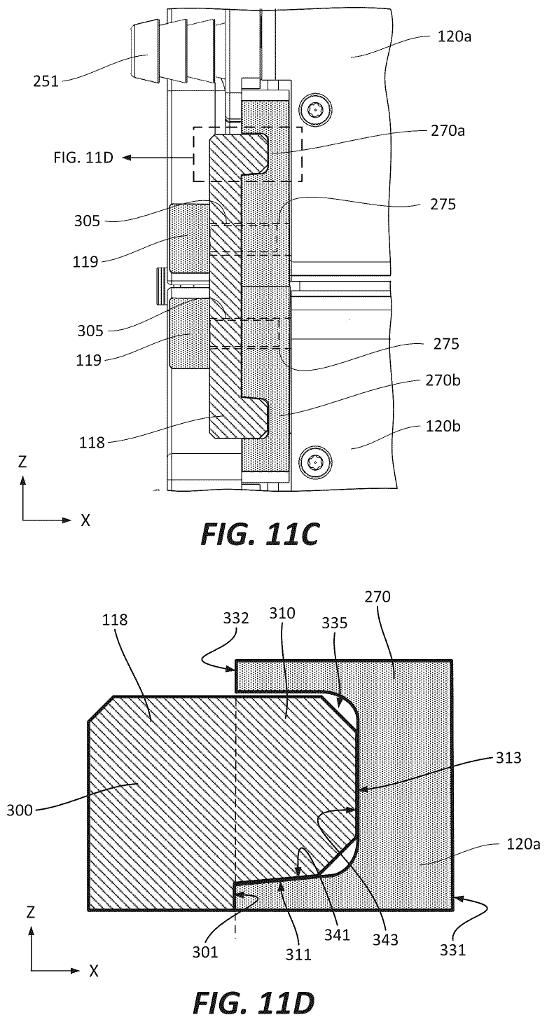

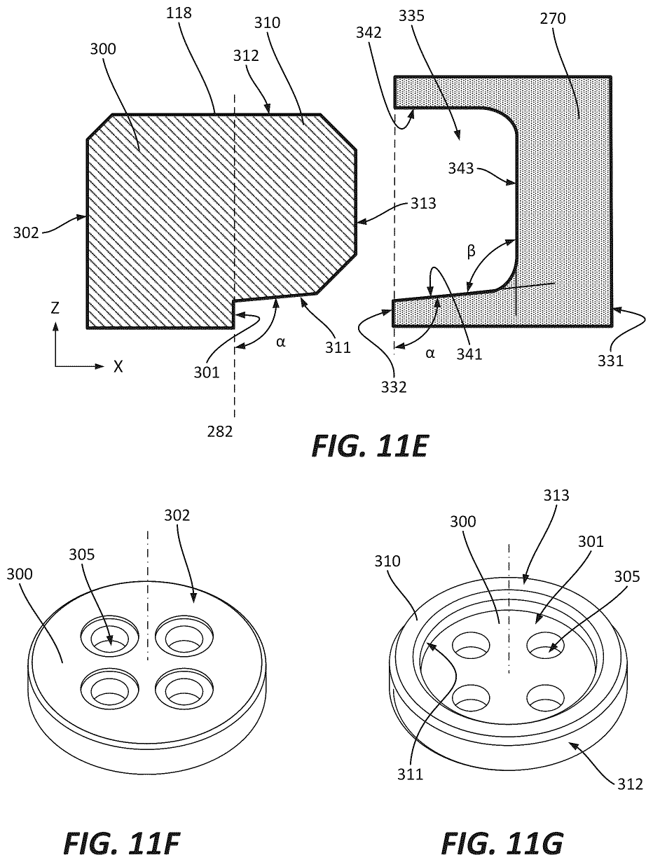

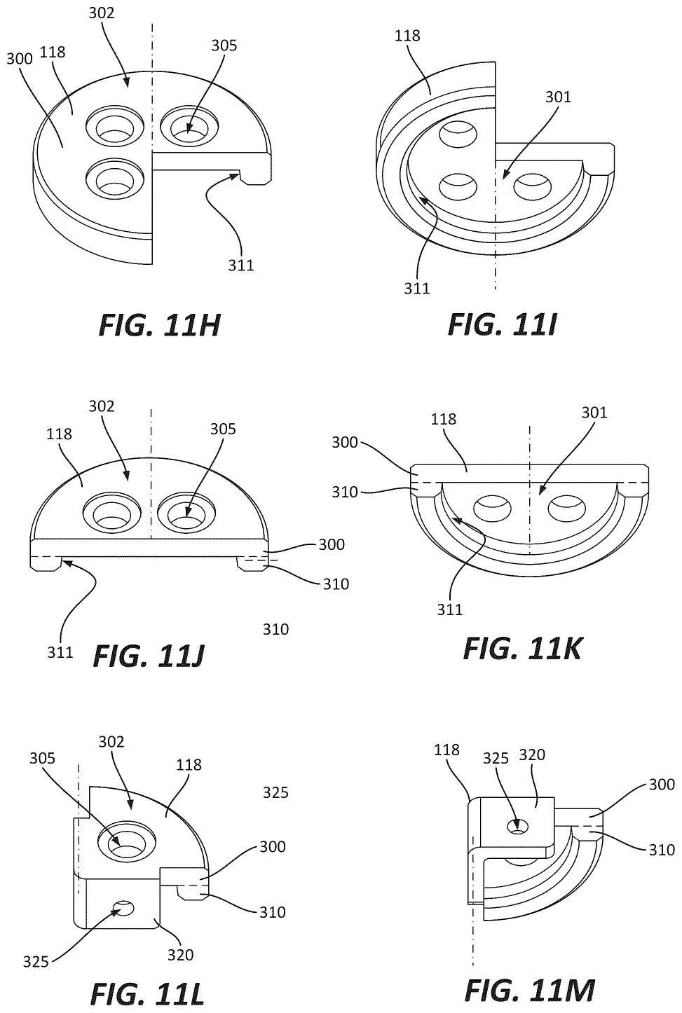

FIGS. 10A-10D are schematic perspective and front views of a battery pack 110 comprising thirteen interconnected battery modules 120, in accordance with some examples. The boundary of each battery module 120 is identified with dashed lines as these boundaries are obscured by end covers 111 in FIG. 10A and by battery-pack busbars 113 in FIGS. 10B-10D. Furthermore, it should be noted that FIGS. 10B-10D illustrate one side of the battery pack 110, i.e., the side with the first end plate 121 each comprising a first fluid port 251 and a second fluid port 252 in addition to an electric contact 254 connected to one of the battery-pack busbars 113). In some examples, a battery pack 110 also comprises mounting rails 116, one on each side of the battery pack 110 (e.g., as shown in FIG. 10A). These mounting rails 116 may be integrated into interconnecting units 118, e.g., along the bottom side of the battery module 120 in the bottom row. For example, FIG. 10B illustrates a front mounting rail 116 comprising five interconnecting units 118, i.e., two quarter-circular interconnecting units 118 (each positioned along the sides of the battery pack 110 and connected to only one battery module 120) and three semicircular interconnecting units 118 (each connected to a pair of battery modules 120). Other interconnecting units 118 may be standalone structures and further described below with reference to FIG. 11F-11M.

In general, a battery pack 110 may comprise any number of battery modules 120. The number and arrangement of the battery modules 120 in battery pack 110 depends on the available space, voltage/current/power/energy requirements, and other factors. Each battery module 120 in a battery pack 110 may be mechanically connected to at least one other battery module 120 using interconnecting units 118, e.g., as shown in FIGS. 10B-10D. Each interconnecting unit 118 may interconnect two, three, or four battery modules 120. Similarly, depending on the location of the battery module 120 in a battery pack 110, this battery module 120 may be connected to two other modules (e.g., referring to the top battery module 120 in FIGS. 10B-10C), three other battery modules (e.g., referring to each corner battery module 120 in FIGS. 10B-10C), five other battery modules (e.g., referring to each battery module 120 in the middle along the edges in FIGS. 10B-10C), six other battery modules (e.g., referring to a battery module 120 right under the top battery module 120 in FIGS. 10B-10C), eight other battery modules (e.g., referring to any interior battery module 120 in FIGS. 10B-10C), or some other number of battery modules. Furthermore, in addition to being mechanically interconnected, the battery modules 120 may be interconnected electrically (e.g., using battery-pack busbars 113 shown in FIG. 10B-10D) and/or fluidically. The electrical connections depend on the voltage/current requirements, while fluidic may depend on cooling requirements. These connections may be covered with and protected by end covers 111 (e.g., as shown in FIG. 10A).

Referring to FIG. 10D, a battery pack 110 comprises at least a first battery module 120a and a second battery module 120b. As noted above, each battery module 120 comprises a first end plate 121, a second end plate 122, prismatic battery cells 130 stacked between the first end plate 121 and the second end plate 122, a top cover 150 attached to the prismatic battery cells 130, and a bottom cover 160 attached to the prismatic battery cells 130. The top cover 150 forms one or more top fluid channels open to each of the prismatic battery cells 130 thereby allowing a thermal liquid to directly contact each of the prismatic battery cells 130. The bottom cover 160 forms one or more bottom fluid channels open to each of the prismatic battery cells 130 thereby allowing the thermal liquid to directly contact each of the prismatic battery cells 130. The first end plate 121 is attached to both the top cover 150 and the bottom cover 160 and comprises a first fluid port 251 and a second fluid port 252 fluidically coupled to one or more top fluid channels and one or more bottom fluid channels. The second end plate 122 is attached to both the top cover 150 and the bottom cover 160 and fluidically interconnects one or more top fluid channels and one or more bottom fluid channels.

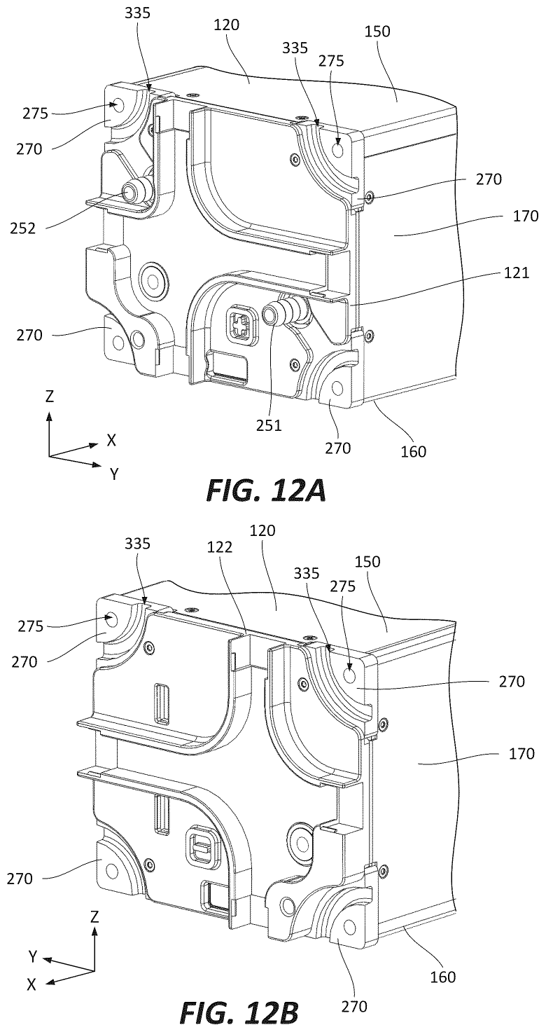

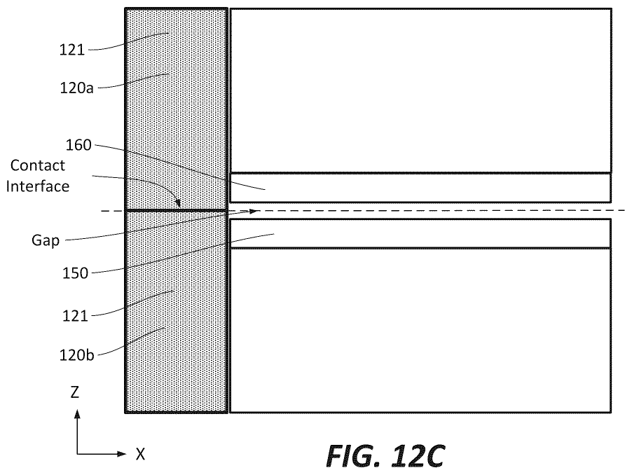

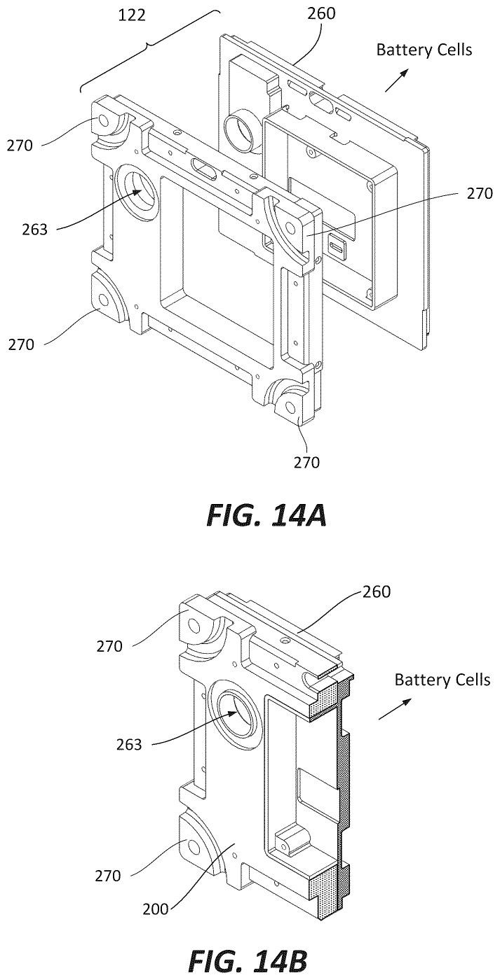

Referring to FIG. 10D, each of the first end plate 121 and the second end plate 122 comprises four engagement units 270 located at corners of the first end plate 121 and the second end plate 122. It should be noted that FIG. 10D illustrates the first end plate 121 of each of the first battery module 120a and the second battery module 120b. The second end plate 122 has a similar arrangement of the engagement units 270 and is further explained below with reference to FIGS. 12B and 14A-14B. Furthermore, the engagement units 270 (in FIG. 10D) are hidden behind interconnecting units 118 and identified with dashed lines.

Referring to FIG. 10D, the first end plate 121 of the first battery module 120a comprises a first-module engagement unit 270a, being a part of the four engagement units 270 of the first end plate 121 of the first battery module 120a. The first end plate 121 of the second battery module 120b comprises a second-module engagement unit 270b, forming at least a part of an engagement unit set 279 together with the first-module engagement unit 270a and being a part of the four engagement units 270 of the first end plate 121 of the second battery module 120b. An interconnecting unit 118 is attached to the engagement unit set 279 and compresses the first-module engagement unit 270a against the second-module engagement unit 270b. Specifically, the interconnecting unit 118 compresses the first-module engagement unit 270a against the second-module engagement unit 270b along the Y axis, thereby supporting the first battery module 120a and the second battery module 120b relative to each other.

FIG. 11A is a schematic perspective view of a portion of the battery pack in FIG. 10B, illustrating an interconnecting unit 118 attached to four battery modules 120, in accordance with some examples. Specifically, the 2 bolted to each battery module 120 or, more specifically, its engagement unit 270 using a fastener 119. FIG. 11B is a schematic perspective view of the same four battery modules 120 with the interconnecting unit removed 118, illustrating the engagement units 270 of these battery modules 120. Specifically, these engagement units 270 form an engagement unit set 279. While in this example, the engagement unit set 279 is formed by four engagement units 270, in other examples, the engagement unit set 279 can be formed by only two engagement units 270 or only three engagement units 270. Furthermore, each engagement unit 270 comprises a threaded opening 275 such that a fastener 119 can be threaded and supported in this threaded opening 275.

FIG. 11C is a schematic cross-sectional view of two battery modules 120 (i.e., a first battery module 120a and a second battery module 120b) and interconnecting unit 118 attached to the engagement units 270 of these battery modules 120 (i.e., a first-module engagement unit 270a and a second-module engagement unit 270b) using fasteners 119. Specifically, a fastener 119 protrudes through each of the first-module engagement unit 270a and the second-module engagement unit 270b and is threaded into the threaded opening 275 of each of the first-module engagement unit 270a and the second-module engagement unit 270b. The interconnecting unit 118 or, more specifically, the base 300 of the interconnecting unit 118 comprises a base opening 305 such that a fastener 119 protrudes through the base opening 305 and is threaded into one of the first-module engagement unit 270a and the second-module engagement unit 270b.

FIG. 11D is an expanded view of the portion of the two battery modules 120 and interconnecting unit 118 in FIG. 11C. Specifically, the interconnecting unit 118 comprises a base 300 and a protrusion 310. The engagement units 270 comprise a unit inner surface 331 and a unit outer surface 332 opposite of the unit inner surface 331. An engagement-unit opening 335 extends from the unit outer surface 332 toward the unit inner surface 331. When the interconnecting unit 118 is attached to the four engagement units 270, the protrusion 310 of the interconnecting unit 118 extends into the engagement-unit opening 335.

FIG. 11E is a corresponding view prior to inserting the protrusion 310 of the interconnecting unit into the engagement-unit opening 335, in accordance with some examples. The protrusion 310 comprises a first protrusion surface 311 and a second protrusion surface 312 opposite of the first protrusion surface 311. The first protrusion surface 311 forms an angle (α) with the base inner surface 301 that is greater than 90° C. In some examples, this angle (α) is 95-120° C. or, more specifically, 100-110°. This angle (α) ensures that the first-module engagement unit 270a is compressed against the second-module engagement unit 270b as the interconnecting unit 118 is attached to both the first-module engagement unit 270a and second-module engagement unit 270b or, more specifically, as the protrusion 310 of the interconnecting unit 118 is being inserted into the engagement-unit openings 335 of the first-module engagement unit 270a and second-module engagement unit 270b. Referring to FIG. 11E, the first protrusion surface 311 directly interfaces each of the first-module engagement unit 270a and the second-module engagement unit 270b or, more specifically, with the first unit-opening surface 341 of these units causing the compression.

Further referring to FIG. 11E, in some examples, the protrusion 310 comprises a third protrusion surface 313 extending parallel to the base inner surface 301. At least one of the base inner surface 301 or the third protrusion surface 313 directly interfaces each of the first-module engagement unit 270a and the second-module engagement unit 270b. This provides a positive stop (along the X-axis) for the interconnecting unit 118 while the interconnecting unit 118 is being attached to the first-module engagement unit 270a and the second-module engagement unit 270b.

Further referring to FIG. 11E, in some examples, the engagement-unit opening 335 is defined by a first unit-opening surface 341, a second unit-opening surface 342, and a third unit-opening surface 343. The first unit-opening surface 341 directly interfaces the first protrusion surface 311 thereby compressing the first-module engagement unit 270a against the second-module engagement unit 270b. The first unit-opening surface 341 forms an angle (β) with the unit outer surface 332 that is greater than 90°. In some examples, this angle (β) is the same as the angle (α), between the first protrusion surface 311 and the base inner surface 301, described above.

Referring to FIGS. 12A and 12B, each engagement-unit opening 335 forms a quarter-circle channel, extending between two orthogonal surfaces of the battery module 120 (e.g., one surface defined by a corresponding side cover 170 and another surface defined by one of the top cover 150 or the bottom cover 160).

In some examples, the four engagement units 270 of each of the first end plate 121 and the second end plate 122 are monolithically connected. For example, each of the first end plate 121 and the second end plate 122 comprises a reinforcement element 200 such that the four engagement units 270 are parts of the reinforcement element 200. In some examples, the reinforcement element 200 may be formed from aluminum.

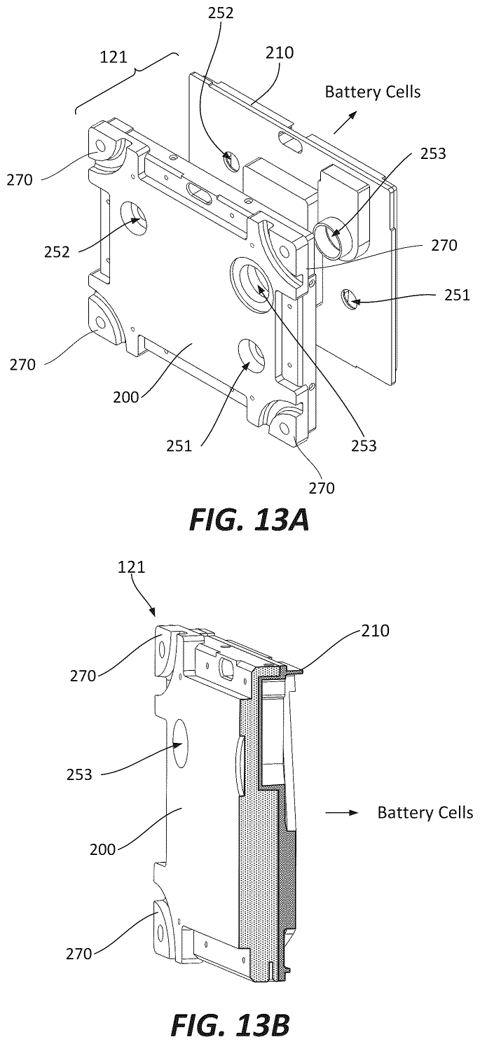

Referring to FIGS. 13A and 13B, in some examples, the first end plate 121 further comprises a first cover 210, positioned between the reinforcement element 200 and the prismatic battery cells 130 and electrically isolating the reinforcement element 200 from the prismatic battery cells 130. The first fluid port 251 and the second fluid port 252 protrude through each of the first cover 210 and the reinforcement element 200. Furthermore, a first contact opening 253 may protrude through each of the first cover 210 and the reinforcement element 200. In some examples, the first cover 210 is glued to each of the reinforcement element 200 and the prismatic battery cells 130.

Referring to FIGS. 14A and 14B, in some examples, the second end plate 122 further comprises a second cover 260, positioned between the reinforcement element 200 and the prismatic battery cells 130 and electrically isolating the reinforcement element 200 from the prismatic battery cells 130. It should be noted that the reinforcement element 200 of the first end plate 121 may be different from that of the second end plate 122. However, each reinforcement element 200 comprises four engagement units 270 that can provide up to 8 connections to each battery module 120. The design of all engagement units 270 may be the same. Furthermore, referring to FIGS. 14A and 14B, a second contact opening 263 may protrude through each of the second cover 260 and the reinforcement element 200. In some examples, the second cover 260 is glued to each of the reinforcement element 200 and the prismatic battery cells 130.

Referring to FIG. 11B, in some examples, the engagement unit set 279 consists of the first-module engagement unit 270a, the second-module engagement unit 270b, and two additional engagement units. In these examples, the interconnecting unit 118 has a circular shape, e.g., as shown in FIGS. 11F-11G. Alternatively, the engagement unit set 279 consists of the first-module engagement unit 270a, the second-module engagement unit 270b, and one additional engagement unit. In these examples, the interconnecting unit 118 has a three-quarter-circular shape, e.g., as shown in FIGS. 11H-11I. Furthermore, the engagement unit set 279 may consist of only the first-module engagement unit 270a and the second-module engagement unit 270b. In this case, the interconnecting unit 118 has a semi-circular shape, e.g., as shown in FIGS. 11J-11K.

FIGS. 11L-11M illustrate another example of an interconnecting unit 118 that connects only to one engagement unit 270, e.g. at the outer corner of the battery pack 110. The purpose of this interconnecting unit 118 is to connect the battery module 120 to an end cover 111 (e.g., as shown in FIG. 10A) or other covers. For example, an interconnecting unit 118 may comprise one or more supporting portions 320, which may extend orthogonal to the base outer surface 302. When two supporting portions 320 are provided, these supporting portions 320 may be orthogonal to each other, e.g., to attach to different battery pack covers. Each supporting portion 320 may comprise a supporting-portion opening 325 (e.g., a threaded opening) for securing a fastener.

Referring to FIG. 12C, in some examples, compressing the first-module engagement unit 270a against the second-module engagement unit 270b also compresses the first end plate 121 of the first battery module 120a against the first end plate 121 of the second battery module 120b. At the same time, the bottom cover 160 of the first battery module 120a faces and is spaced away from the top cover 150 of the second battery module 120b when the first end plate 121 of the first battery module 120a against the first end plate 121 of the second battery module 120b. As such, the first end plate 121 (and the second end plate 122) or, more specifically, their reinforcement element 200 may be used to transfer loads between different battery modules 120 in a battery pack 110.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A battery pack comprising:
a first battery module and a second battery module, each comprising a first end plate, a second end plate, prismatic battery cells stacked between the first end plate and the second end plate, a top cover attached to the prismatic battery cells, and a bottom cover attached to the prismatic battery cells, wherein:
the top cover forms one or more top fluid channels open to each of the prismatic battery cells thereby allowing a thermal liquid to directly contact each of the prismatic battery cells,
the bottom cover forms one or more bottom fluid channels open to each of the prismatic battery cells thereby allowing the thermal liquid to directly contact each of the prismatic battery cells,
the first end plate is attached to both the top cover and the bottom cover and comprises a first fluid port and a second fluid port fluidically coupled to the one or more top fluid channels and the one or more bottom fluid channels,
the second end plate is attached to both the top cover and the bottom cover and fluidically interconnects the one or more top fluid channels and the one or more bottom fluid channels,
each of the first end plate and the second end plate comprises four engagement units located at the corners of the first end plate and the second end plate,
the first end plate of the first battery module comprises a first-module engagement unit, being a part of the four engagement units of the first end plate of the first battery module, and
the first end plate of the second battery module comprises a second-module engagement unit, forming at least a part of an engagement unit set together with the first-module engagement unit and being a part of the four engagement units of the first end plate of the second battery module; and
an interconnecting unit is attached to the engagement unit set and compresses the first-module engagement unit against the second-module engagement unit.

2. The battery pack of claim 1, wherein:
each of the four engagement units comprises a threaded opening, and
the interconnecting unit is attached to each of the first-module engagement unit and the second-module engagement unit using a fastener protruding through each of the first-module engagement unit and the second-module engagement unit and threaded into the threaded opening of each of the first-module engagement unit and the second-module engagement unit.

3. The battery pack of claim 1, wherein:
the interconnecting units comprises a base and a protrusion,
the base comprises a base inner surface and a base outer surface opposite of the base inner surface,
the protrusion extends from the base inner surface in a direction away from the base outer surface,
the protrusion comprises a first protrusion surface and a second protrusion surface opposite of the first protrusion surface, and
the first protrusion surface forms an angle greater than 90° with the base inner surface and directly interfaces each of the first-module engagement unit and the second-module engagement unit thereby compressing the first-module engagement unit against the second-module engagement unit.

4. The battery pack of claim 3, wherein:
the protrusion comprises a third protrusion surface extending parallel to the base inner surface, and
at least one of the base inner surface or the third protrusion surface directly interfaces each of the first-module engagement unit and the second-module engagement unit.

5. The battery pack of claim 3, wherein the base further comprises a base opening such that a fastener protrudes through the base opening and is threaded into one of the first-module engagement unit and the second-module engagement unit.

6. The battery pack of claim 3, wherein:
each of the four engagement units comprising a unit inner surface and a unit outer surface opposite of the unit inner surface,
an engagement-unit opening extending from the unit outer surface toward the unit inner surface, and
the protrusion of the interconnecting unit extends into the engagement-unit opening.

7. The battery pack of claim 6, wherein:
the engagement-unit opening is defined by a first unit-opening surface, a second unit-opening surface, and a third unit-opening surface, and
the first unit-opening surface directly interfaces the first protrusion surface thereby compressing the first-module engagement unit against the second-module engagement unit.

8. The battery pack of claim 7, wherein the first unit-opening surface forms an angle greater than 90° with the unit outer surface.

9. The battery pack of claim 8, wherein the angle between the first unit-opening surface and the unit outer surface is the same as the angle between the first protrusion surface and the base inner surface.

10. The battery pack of claim 6, wherein the engagement-unit opening forms a quarter-circle channel.

11. The battery pack of claim 1, wherein the four engagement units of each of the first end plate and the second end plate are monolithically connected.

12. The battery pack of claim 1, wherein each of the first end plate and the second end plate comprises a reinforcement element such that the four engagement units are parts of the reinforcement element.

13. The battery pack of claim 12, wherein:
the first end plate further comprises a first cover, positioned between the reinforcement element and the prismatic battery cells and electrically isolating the reinforcement element from the prismatic battery cells, and
the first fluid port and the second fluid port protrude through each of the first cover and the reinforcement element.

14. The battery pack of claim 13, wherein the first cover is glued to each of the reinforcement element and the prismatic battery cells.

15. The battery pack of claim 1, wherein:
the first end plate and the second end plate comprises an electric contact,
the electric contact on the first end plate of the first battery module has a different polarity from the electric contact on the first end plate of the second battery module.

16. The battery pack of claim 1, wherein:
the engagement unit set consists of only the first-module engagement unit and the second-module engagement unit, and
the interconnecting unit has a semi-circular shape.

17. The battery pack of claim 1, wherein:
the engagement unit set consists of the first-module engagement unit, the second-module engagement unit, and one additional engagement unit, and
the interconnecting unit has a three-quarter-circular shape.

18. The battery pack of claim 1, wherein:
the engagement unit set consists of the first-module engagement unit, the second-module engagement unit, and two additional engagement units, and
the interconnecting unit has a circular shape.

19. The battery pack of claim 1, further comprising an end cover enclosing the first end plate of each of the first battery module and the second battery module and connected to the interconnecting unit.

20. The battery pack of claim 1, wherein:
compressing the first-module engagement unit against the second-module engagement unit also compresses the first end plate of the first battery module against the first end plate of the second battery module, and
the bottom cover of the first battery module faces and spaced away from the top cover of the second battery module when the first end plate of the first battery module against the first end plate of the second battery module.
